(19) United States
(12) Patent Application Publication
(10) Pub. No.: US 2026/0074588 A1
(43) Pub. Date: Mar. 12, 2026

(54) SPRING-POWERED ASSEMBLY AND SYSTEM CONTAINING ELECTROMAGNETIC WHEEL FOR GENERATING ELECTRICITY

(71) Applicant: Mark Silvestri, Cranston, RI (US)

(72) Inventor: Mark Silvestri, Cranston, RI (US)

(21) Appl. No.: 19/320,475

(22) Filed: Sep. 5, 2025

Related U.S. Application Data
(60) Provisional application No. 63/691,778, filed on Sep. 6, 2024.

(51) Int. Cl. H02K 7/18; H02K 7/00; H02K 7/116

(52) U.S. Cl. CPC H02K 7/1807; H02K 7/003; H02K 7/116

(57) ABSTRACT

The present invention provides a spring-powered assembly and system including a rotating wheel containing magnets for generating electricity. The spring-powered assembly includes multiple parts. Particularly, the spring-powered assembly includes: i) a rotatable shaft positioned in a housing unit; ii) a spring having a first end attached to the housing unit and a second end attached to the shaft; iii) a locking pin; iv) a gear box; v) an electromagnetic wheel that activates magnets attached to a rotating wheel; vi) a second gear box; and vii) a second alternator. The spring-powered assembly preferably includes magnets attached to a magnet assembly. The rotatable shafts can use magnetism generated by the magnets to assist the springs in rotating the rotatable shafts. The generated electrical energy can be used to power large-scale and small-scale operations and devices such as commercial buildings, electric vehicles, cellular phones, and laptops.

### CROSS-REFERENCE TO RELATED APPLICATIONS

The application claims the benefit of U.S. Provisional Patent Application No. 63/691,778 filed Sep. 6, 2024, the entire disclosure of which is hereby incorporated by reference.

### BACKGROUND OF THE INVENTION

### Field of the Invention

The present invention generally relates to a spring-powered assembly and system including a rotating wheel containing magnets for generating electricity.

### Brief Review of the Related Art

In general, many electrical generators convert mechanical energy into electrical energy by the mechanism of electromagnetic induction. For example, magnets having two poles - north and south can be placed in position as a rotor and move in a rotary direction. A wired copper coil can be placed in position as the stationary stator. When the magnets rotate, the electrons in the copper coil are activated and move in different directions. The rotational movement of the magnets with respect to the copper coil generates alternating electrical current (AC) by electromagnetic induction. The alternating electrical current is converted to direct electrical current by an AC to DC converter. The recovered electrical energy can be stored in a battery.

Many conventional electrical generators are powered by fossil fuels such as diesel and gasoline. However, one problem with such traditional electric generators is they can produce exhaust gases that can lead to air pollution. Such generators also can have low operating efficiency because they may consume high amounts of fuel in order to generate a sufficient amount of electrical energy.

In recent years, electrical generators that use non-fossil fuels such as, for example, hydro-electric power systems and wind-operated systems have become more popular, but these systems also have some disadvantages. For example, wind turbines can be used to drive some electric power generating systems, but they require large land or ocean areas and need steady wind currents. Solar energy systems are dependent upon sunlight. Also, the initial costs of constructing and installing solar panels can be expensive. The construction of hydro-electric dams can have negative environmental impacts. There are limited reservoirs, lakes, and river areas, where such dams and power plants can be built.

Other electrical generating systems that do not use fossil or non-fossil fuels have been developed. For example, Francis, U.S. Patent Application Publication 2015/0159636 discloses a spring-based generator for conversion of the vibrational energy into storable electrical energy. The generator is portable and does not need any fuel such as diesel, water, or the like for its starting or running. Each phase of the spring assembly comprises an input spring drum, a highly compressed spring coil, and an output spring drum. The input spring drum with gear is connected to the electric motor through a secondary gear. The highly compressed spring coil stores potential energy that is converted into kinetic energy. The multiple spring assemblies are cranked by the input spring drum assembly on one side. The primary transmission gear transmits power from one spring assembly to another. The secondary transmission gear transfers the energy to the bearing. The alternator converts the power transferred from the bearing to the electrical current. An output is taken from the alternator. Feedback is taken from the alternator to the electric motor. The coupling maintains continuity of power flow from the bearing to the alternator. The power supply acts as the feedback to the electric motor. However, one problem with the Francis '636 patent Publication is that the power is recycled continuously in a closed loop without an external power source and thus would not operate reliably.

There is a need for an improved system for producing electricity that does not adversely affect the environment and is reliable and safe for consumers. The system should be easy to operate, cost-effective, and efficient. The present invention provides such a system. Other advantages, features, and benefits of the present invention are described further below.

### SUMMARY OF THE INVENTION

The present invention provides a spring-powered assembly and system including a rotating wheel containing magnets for generating electricity. The spring-powered assembly and system include multiple parts. Particularly, the spring-powered assembly and system include: i) a rotatable shaft positioned in a housing unit; ii) a spring having a first end attached to the housing unit and a second end attached to the shaft; iii) a locking pin; iv) a gear box; v) an electromagnetic wheel that activates magnets attached to a rotating wheel; vi) a second gear box; and vii) a second alternator.

The spring-powered assembly preferably includes magnets attached to a magnet assembly. The magnets can be held above the rotatable shafts. The magnets can be activated, and the magnet sub-assembly retracts by a spring that is attached to the housing unit. Locking pins can also be secured to the magnet sub-assembly. The rotatable shafts can use magnetism generated by the magnets to assist the springs in rotating the rotatable shafts.

The generated electrical energy can be used to power large-scale and small-scale operations and devices such as, for example, commercial buildings, hospitals, schools, electric vehicles, cellular phones, laptops, and personal computers.

More particularly, the spring-powered assembly comprises: a) a first rotatable shaft positioned in a housing unit, the rotatable shaft having a first end and a second end; b) a spring having a first end attached to the housing unit and a second end attached to the rotatable shaft, wherein the rotatable shaft is first rotated to preload the spring to a desired tension level; c) c) a locking pin, the locking pin being secured to the spring and housing unit, thereby locking the spring to the housing unit and preventing the spring from unwinding from the rotatable shaft; and secondly pulling the locking pin from the housing unit so that the spring is free to unwind from the rotatable shaft and the shaft can rotate; d) an input second rotatable shaft for a gear box that is coupled to the first rotatable shaft, the gear box containing a gear multiplier and having an output third rotatable shaft for transmitting mechanical energy to an alternator; and e) an alternator for transforming the mechanical energy from the output rotatable shaft of the gearbox into electrical energy.

The assembly preferably further comprises: f) a lever having an attached electromagnet; g) a rotatable wheel having magnets attached to the wheel, wherein the electrical energy generated from above Step e) drives the electromagnet so that the electromagnet can activate the magnets attached to the rotating wheel, and cause the wheel to rotate, the wheel being coupled to an output fourth rotatable shaft; h) an input fifth rotatable shaft for a gear box that is coupled to the output fourth rotatable shaft, the gear box containing a gear multiplier and having an output sixth rotatable shaft for transmitting mechanical energy to an alternator; and i) an alternator for transforming the mechanical energy from the output rotatable shaft of the gearbox into electrical energy.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a schematic diagram showing one embodiment of the spring-powered assembly and system for generating electrical power of the present invention;

FIG. 2 is a schematic diagram showing one embodiment of a crank-shaft sub-assembly, which is a component in the spring-powered assembly and system of the present invention;

FIG. 3 is a schematic diagram showing one embodiment of magnetic sub-assemblies for holding magnets in the crank-shaft sub-assembly;

FIG. 4 is a schematic diagram showing one embodiment of the crank-shaft sub-assembly showing magnetic sub-assemblies, springs, and locking pins;

FIG. 5 is a schematic diagram showing one embodiment of the crank-shaft sub-assembly showing magnetic sub-assemblies, springs, locking pins; and emergency shut-off button; and

FIG. 6 is a schematic diagram showing another embodiment of the spring-powered assembly and system for generating electrical power of the present invention.

### DETAILED DESCRIPTION OF THE INVENTION

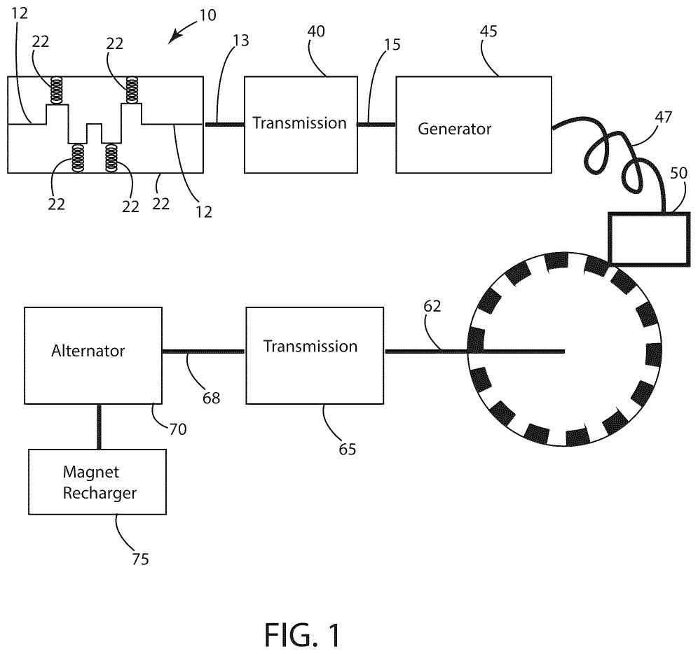

Referring to FIG. 1, one embodiment of the spring-powered assembly and system of the present invention is shown. The different components (parts) of the assembly and system are described further below.

### Part One—Power

Referring to FIG. 1, the crank-shaft sub-assembly (10) includes a shaft (12), which is free to rotate in the sub-assembly. More particularly, Part One includes a shaft (12) that is free to rotate in a housing unit (20). A spring (22), or other suitable elastic member such as, for example, a bungee cord, includes a first end that is attached to the housing unit (20) and a second end that is attached to the shaft (12). The highly wound spring (22) is under substantial tension and stores potential energy that will be transferred into kinetic energy, that is later used to generate electrical energy.

The rotatable shaft (12) has a first end that is positioned in a bearing of the housing unit (20) so that the shaft can rotate easily. The rotatable shaft (12) also includes a second end. The first end of the spring (22) is attached to the housing unit (20), and an opposing second end of the spring is attached to the rotatable shaft (12).

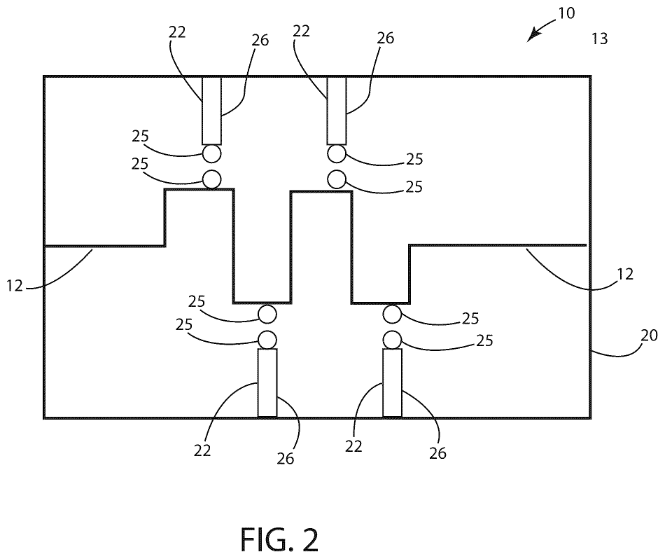

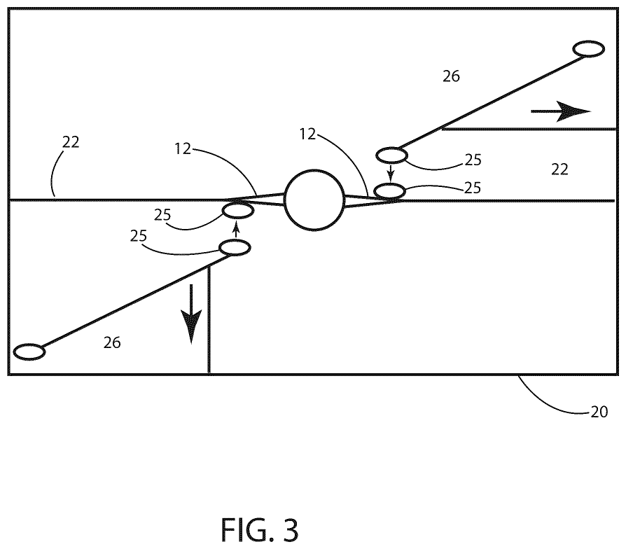

Referring to FIGS. 2 and 3, detachable magnets (25), for example, rare earth magnets, can be added to the shaft (12) and the housing unit (20) with the springs (22). The magnets (25) will generate additional force to assist the springs (22) to rotate the shaft (12). These magnets (25) are detachable in order that they can be easily replaced in the event that they lose their magnetism over time. The magnets (25) are connected through another series of rods, known as the magnet sub-assembly (26). The magnet sub-assemblies (26) are attached to a swivel at the base of the housing unit (20). The magnet sub-assemblies (26) hang over the shaft (12) with a magnet (25) at the top of the sub-assembly. Magnets (25) are also attached to the shaft (12) and aligned with the magnets (25) on the magnet sub-assemblies (26). This structure allows the magnets (25) to assist the springs (22) and move the shaft (12) by magnetism and maintain continuous rotation.

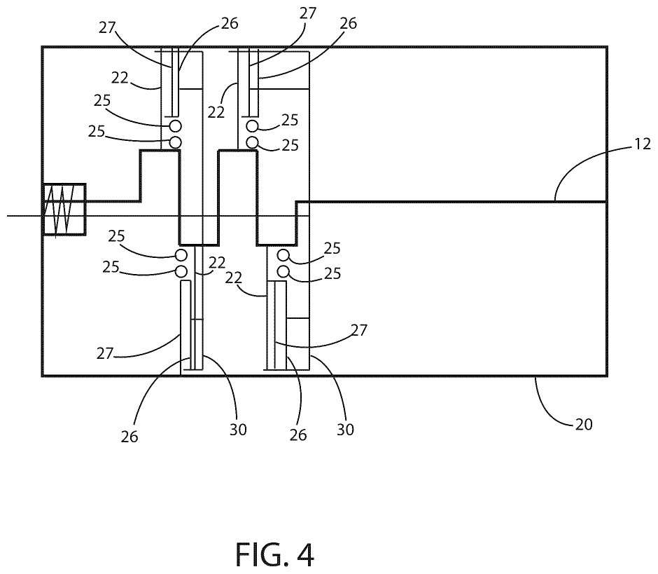

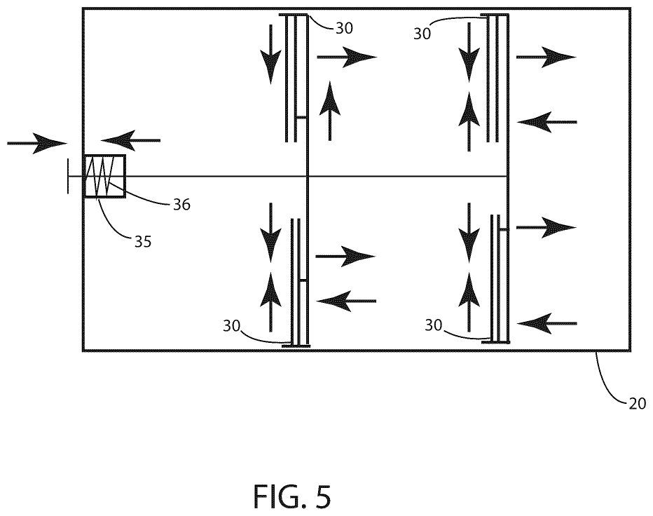

In FIG. 3, the spring (22) is shown attached to the shaft (12) and housing unit (20). The spring (22) uses pulling tension to move the shaft (12). The magnets (25) use magnetism to move the shaft (12) and maintain continuous rotation The magnet assemblies (26) hold the magnets (25) near the shaft (12). As shown in FIG. 3, the magnets (25) are lined up with the shaft (12). The spring (22) exerts tension as shown by the downward arrow. As described further below and shown in FIGS. 4 and 5, when an emergency shut-off button (35) is pressed, the locking pins (30) release the spring tension, thus pulling the magnet sub-assemblies (26) away from the magnets (25) on the shaft (12).

First, the shaft (12) is rotated to pre-load the spring (22) to a desired tension level. As shown in FIGS. 1 to 6, there can be multiple spring segments (22). One end of a spring segment (22) is attached to one rotatable end section of the shaft member (12). The other end of the spring segment is attached to a locking pin (30). The locking pin (30) is secured to the housing unit (20). In this manner, the rotatable shaft (12) is locked to the housing unit (20) and the spring (22) is prevented from unwinding from the shaft (12). The spring-powered assembly and system of the present invention are now ready to be used for generating electricity. In practice, the locking pin (30) is pulled from the housing unit (20), thereby releasing the tension on the spring (22) so that the spring is free to unwind from the housing unit (20), while still attached to the shaft (12). By releasing the tension from the housing unit (20), and with the springs (22) now only being attached to the rotatable shaft (12), the stored energy of the springs is released and no longer functionable, thus powering down the system.

The springs (22) can be easily reattached, storing the energy once again and with a simple spin of the shaft (10) will power the generator up again to produce energy. The locking pins (30) are attached to a series of rods that are attached to an emergency shut-off button (35). The button (35) is powered by a separate spring (36). This separate spring (36) allows for the locking pin (30) to stay in place to secure the springs (22), that are used to power the shaft (12), to the housing unit (20).

As shown in FIG. 4, the locking pins (30) also hold the magnet assemblies (26) in place. The bottom of the magnet sub-assembly (26) is attached to the housing unit (20) by a swivel, allowing it to move up and down. The magnet sub-assembly (26) is locked in by the locking pin sub-assembly (30). The magnet sub-assembly (26) also has a spring (22) that is attached from the top of the sub-assembly to the bottom of the housing unit (20). When the emergency button (35) is pressed, the spring tension will pull the magnet sub-assembly (26) away from the shaft (12), effectively subtracting the magnetism from continuing to assist with the rotation of the shaft (12). The emergency shut-off button (35) will end all magnetism and spring tension designed to move the shaft (12) because the locking pins (30) are all connected into a series of rods that make up the locking pin sub-assembly.

Referring more particularly to FIG. 5, when the emergency shut-off button (35) is pressed, the locking pin sub-assembly (30) will slide the locking pins (30) out of position. When the locking pins (30) slide out of position, the springs (22) are released from the housing unit (20). When the emergency shut-off button (35) is pressed, it compresses a spring, creating tension. When the emergency shut-off button (35) is released, the spring, which is under tension, will move the locking pin sub-assembly (31), including the locking pins (30), back into position. Since the springs (22), which are attached to the rotatable shaft (12) were under tension when they were released from the locking pins (30), they will not reattach to the housing unit (20), unless done manually.

The emergency shut-off button (35) is also connected to the rods that hold the magnets (25). There is a rod that is connected to another series of rods that hold the magnet assemblies (26) in place. When the button (35) is pressed, it will release the magnet sub-assembly (26) and the spring tension, which is attached to the magnet sub-assembly (26), retracts towards the edge of the housing unit (20) and away from the rotatable shaft (12).

As a result, the potential energy stored in the spring (22) is transferred to the shaft (12) as kinetic energy. As described further below, there is a downstream alternator (45) that transforms the kinetic energy to electrical energy to power the selected devices. Once the potential energy stored in the spring (22) is transferred to the shaft sub-assembly, the shaft will continue to rotate with respect to the end member, until the process ends.

### Part Two—Gear Box for Enhancing Power

Turning back to FIG. 1, as the output shaft (12) from the crank shaft sub-assembly (10) rotates and generates mechanical energy, this energy is transmitted to a gearbox (40). There is an input shaft (12) for the gearbox (40) that is coupled to the output shaft (12). The gearbox preferably includes a gear multiplier.

More particularly, the second end of the shaft (12) is coupled to the gearbox (40), thus allowing it to transmit the rotation of the shaft (12) to the gearbox (40). In one preferred embodiment, the gearbox (40) includes an element for varying the rotational speed. For example, the change in rotational speed can be based on an input shaft and output shaft (12) for the gearbox (40), so that the input shaft of the gearbox (40) has a low speed and the output shaft of the gearbox (40) has a high speed. In this preferred embodiment, the gearbox includes a gear multiplier. In other embodiments, drive belts can be used to vary the speed of the output shaft with respect to the input shaft.

### Part Three—Alternator

The gearbox (40) is coupled with the alternator (45). The alternator (45) receives the mechanical energy transmitted from the output shaft (12) of the gearbox (40) and transforms that mechanical energy into electrical energy. The alternator (45) transmits this electrical energy for Part Four—Electromagnetic Power Input, as described further below.

### Part Four—Electromagnetic Power Input

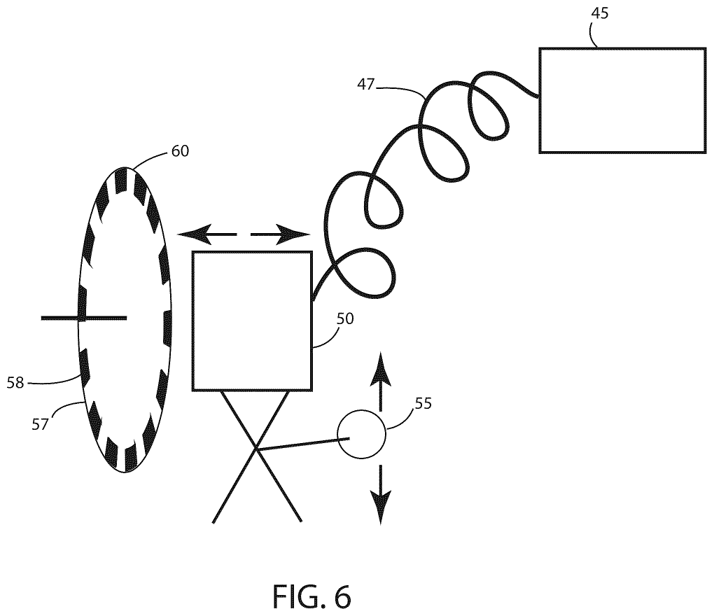

Referring to FIG. 6, the electrical energy generated in Parts One, Two, and Three, as described above, is used to drive an electromagnet (50) and generate a magnetic field. In particular, the power that is generated from the alternator (45) shown in FIG. 1 is transmitted to the electromagnet (50) via wire/power cord (47). The strength of the electromagnet (50) can be changed by changing the amount of electric current from the alternator (45) that runs through the electromagnet (50). A lever (55) is used to place the electromagnet (50) in position so that it activates the magnets (58) fastened to the rotating wheel (60). The magnets (58) are arranged on the wheel (60) and each of them faces the same pole of the electromagnet (50) on the lever (55). As the first magnet (58) on the wheel (60) approaches a second magnet (59), the first magnet (58) repels the second magnet (59). Due to this repulsive force, the opposing magnets (58, 59) will rotate and cause the wheel (60) to continuously rotate.

### Part Five—Gear Box for Enhancing Power

The electromagnetic wheel (60) is coupled to a shaft (62), and the wheel rotates about the axis of the shaft. The rotation of the wheel (60) generates mechanical energy, and this energy is transmitted to a gearbox (65) as shown in FIG. 1. There is an input shaft (62) for the gearbox (65) and an output shaft (66). The gearbox (62) preferably includes a gear multiplier.

More particularly, the second end of the shaft (62) is coupled to the gearbox (65), thus allowing the wheel (60) to transmit rotation of the shaft (62) to the gearbox (65). In one preferred embodiment, the gearbox (65) includes an element for varying the rotational speed. For example, the change in rotational speed can be based on an input shaft (62) and output shaft (68) for the gearbox (65), so that the input shaft (62) of the gearbox has a low speed and the output shaft (68) of the gearbox (65) has a high speed. In this preferred embodiment, the gearbox (65) includes a gear multiplier. In other embodiments, drive belts can be used to vary the speed of the output shaft (68) with respect to the input shaft (62). As shown in FIG. 1, the gearbox (65) includes an output shaft (68) that is coupled to an alternator (70).

### Part Six—Alternator

The alternator (70) receives the mechanical energy transmitted from the output shaft (68) of the gearbox (65) and transforms this mechanical energy into electrical energy. The electricity generated from the electric generating spring-powered assembly and system of the present invention can be used to charge a battery. Electrical power can be tapped from the battery to drive a load. The generated electrical energy can be used to power large-scale and small-scale operations and devices such as, for example, large electrical power systems for homes and commercial buildings, hospitals, schools, and electric vehicles. Also, the electrical energy can be used to power smaller devices such as, for example, cellular phones, laptops, personal computers, and the like.

A unit (75) to recharge the magnets can be coupled to the final alternator/generator (70) of the system. The magnet charger can be used to recharge any magnets that may lose magnetism. To determine the loss of the magnetism, a gaussmeter or Telemeter can be used.

It is also recognized that sensors can be added throughout the system to monitor temperatures, electrical output, and other attributes needed so the consumer will be able to view the performance of the generator. This information can be displayed on a digital screen, analog dash that is similar to a display screen in a car, or both. The information can be transmitted using radio waves, WIFI, Bluetooth, or other means so the consumer for easy of having to physically inspect the generator. This information is helpful in providing preventive maintenance.

In practice, the assembly and system of the present invention can be used to transfer energy in multiple segments. For example, referring to FIG. 6, the electrical energy generated in Parts One, Two, and Three, as described above, can be used to drive an electromagnet and generate a magnetic field as shown in Parts Four, Five, and Six. After the alternator (Part 3) transmits the electrical energy to the Part Four step (Electromagnetic Power Input), then Parts 4-6 steps may be repeated continuously, with the equipment for generating the electricity increasing in size to produce more power. For example, the alternator from Part 3 can generate power for multiple Part 4 steps. Another example is the gear box from Part 5 can connect to multiple alternators thus making multiple Part 6 steps. The system may repeat Part 4-6 steps several times to produce enough power for neighborhoods, towns, or ships. These are only some examples of how the system may operate and should not be construed as limiting the scope of the invention. There are numerous ways that the system of the present invention can split-off into multiple systems for generating power. The purpose of splitting the system into multiple lines for generating electricity is to maximize the production of electricity.

It should be understood the terms, “first”, “second”, “third”, top”, “bottom”, “above”, “below”, “up”, “down”, and the like are arbitrary terms used to refer to one position of an element based on one perspective and should not be construed as limiting the scope of the invention.

It also should be understood that the devices, assemblies, sub-assemblies, systems, constructions, materials, processes, and the like described and illustrated herein represent only some embodiments of the invention. It is appreciated by those skilled in the art that various changes and additions can be made to the devices, assemblies, sub-assemblies, systems, constructions, materials, processes, and the like herein without departing from the spirit and scope of this invention. It is intended that all such embodiments be covered by the appended claims.

I claim:

1. A spring-powered assembly for generating electricity, comprising:
a) a first rotatable shaft positioned in a housing unit, the rotatable shaft having a first end and a second end;
b) a spring having a first end attached to the housing unit and a second end attached to the rotatable shaft, wherein the rotatable shaft is first rotated to preload the spring to a desired tension level;
c) a locking pin, the locking pin being secured to the spring and housing unit, thereby locking the spring to the housing unit and preventing the spring from unwinding from the rotatable shaft; and secondly pulling the locking pin from the housing unit so that the spring is free to unwind from the rotatable shaft and the shaft can rotate;
d) an input second rotatable shaft for a gear box that is coupled to the first rotatable shaft, the gear box containing a gear multiplier and having an output third rotatable shaft for transmitting mechanical energy to an alternator; and
e) an alternator for transforming the mechanical energy from the output rotatable shaft of the gearbox into electrical energy.

2. The spring-powered assembly of claim 1, further comprising magnets attached to a magnet sub-assembly.

3. The spring-powered assembly of claim 2, wherein the locking pin is secured to the magnet sub-assembly.

4. The spring-powered assembly of claim 3, wherein the magnet sub-assembly holds a magnet above the rotatable shafts.

5. The spring-powered assembly of claim 3, wherein the magnet is activated, and the magnet sub-assembly retracts by a spring that is attached to the housing unit.

6. The spring-powered assembly of claim 2, wherein the rotatable shafts can use magnetism generated by the magnets to assist the springs in rotating the rotatable shafts.

7. The apparatus of claim 1, further comprising:
f) a lever having an attached electromagnet;
g) a rotatable wheel having magnets attached to the wheel, wherein the electrical energy generated from Step e) drives the electromagnet so that the electromagnet can activate the magnets attached to the rotating wheel, and cause the wheel to rotate, the wheel being coupled to an output fourth rotatable shaft;
h) an input fifth rotatable shaft for a gear box that is coupled to the output fourth rotatable shaft, the gear box containing a gear multiplier and having an output sixth rotatable shaft for transmitting mechanical energy to an alternator; and
i) an alternator for transforming the mechanical energy from the output shaft of the gearbox into electrical energy.
